(19) United States
(12) Patent Application Publication
(10) Pub. No.: US 2026/0193553 A1
(43) Pub. Date: Jul. 9, 2026

(54) METHODS OF TRANSPORTING HYDROGEN UTILIZING HYDROCRACKING AND DEHYDROGENATION AT SEPARATE HYDROCARBON PROCESSING FACILITIES

(71) Applicant: Saudi Arabian Oil Company, Dhahran (SA)

(72) Inventors: Guanghui Zhu, Dhahran (SA); Faisal Almulla, Dhahran (SA); Anas S. Al-Aqeeli, Dhahran (SA)

(73) Assignee: Saudi Arabian Oil Company, Dhahran (SA)

(21) Appl. No.: 19/010,629

(22) Filed: Jan. 6, 2025

(51) Int. Cl. C10G 69/02; B67D 7/04

(52) U.S. Cl. CPC C10G 69/02; B67D 7/04; C10G 2300/1037; C10G 2400/20

(57) ABSTRACT

In some embodiments, a method of transporting hydrogen, may comprise: at a first hydrocarbon processing facility, hydrocracking a hydrocarbon feed comprising naphtha to form a hydrocracked effluent, transporting the hydrocracked effluent, or a portion thereof, from the first hydrocarbon processing facility to a second hydrocarbon processing facility, and at the second hydrocarbon processing facility, dehydrogenating a portion of the hydrocracked effluent to form hydrogen gas. The first hydrocarbon processing facility and the second hydrocarbon processing facility may be at least 100 km apart from one another.

### TECHNICAL FIELD

Embodiments of the present disclosure generally relate to hydrogen processing and, more specifically, to methods and systems utilized to transport hydrogen.

### BACKGROUND

Hydrogen is growing in importance as an environmentally friendly precursor chemical and fuel. Processes for the production and usage of hydrogen are relatively well developed. However, processes for the storage and transportation of hydrogen are still insufficient to meet the needs of the hydrogen industry. Generally, hydrogen is stored and transported in the form of compressed gaseous hydrogen molecules (e.g., at above 5,000 pounds per square inch). However, these conventional gaseous hydrogen transportation techniques are costly and inefficient. For example, the compression process consumes a large amount of energy (estimated to be 30% or more of the energy content of the hydrogen). Also, transport and storage of the compressed hydrogen requires expensive pressure vessels. Some of the hydrogen molecules can even escape through the walls of hydrogen containment vessels or cause embrittlement of storage and transport vessels. Overall, better methods of hydrogen storage and transport are needed.

### BRIEF SUMMARY

Embodiments of the present disclosure, according to one or more embodiments, provide methods of transporting hydrogen by hydrocracking a hydrocarbon feed comprising naphtha at a first hydrocarbon processing facility to produce a hydrocracked effluent, and then transporting portions of the hydrocracked effluent to one or more additional hydrocarbon processing facilities where the hydrocracked effluent is dehydrogenated. For example, when naphtha is used as a hydrocarbon feed, a portion or all of the naphtha may be reacted with hydrogen in a hydrocracking reaction to form a hydrocracked effluent that is more easily transportable than hydrogen gas. Generally, this hydrogenated effluent is easier to liquefy or otherwise transport and store than hydrogen. Then, the hydrocracked effluent may be separated into one or more cuts or streams and then those streams are transported to one or more additional hydrocarbon processing facilities where it is dehydrogenated to form a valuable petrochemical product along with hydrogen. The hydrogen may be, thus, transported between hydrocarbon processing facilities, and valuable petrochemical products are also formed at the additional hydrocarbon processing facilities that can be locally consumed or sold. In such embodiments, hydrogen may be transported over vast distances, such as between countries or continents, without the need for costly hydrogen gas pressurization.

According to one or more embodiments, a method of transporting hydrogen may comprise: at a first hydrocarbon processing facility, in a catalytic hydroprocessing reactor, hydrocracking a hydrocarbon feed comprising naphtha in the presence of hydrogen gas to form a hydrocracked effluent, wherein the hydrocracked effluent has a greater ratio of hydrogen to carbon than the hydrocarbon feed; at the first hydrocarbon processing facility, separating the hydrocracked effluent into at least a first hydrogenated hydrocarbon cut and a second hydrogenated hydrocarbon cut; transporting the first hydrogenated hydrocarbon cut and the second hydrogenated hydrocarbon cut from the first hydrocarbon processing facility to one or more additional hydrocarbon processing facilities, wherein the first hydrocarbon processing facility and the one or more additional hydrocarbon processing facilities are at least 100 km apart from one another; at the additional hydrocarbon processing facility to which the first hydrogenated hydrocarbon cut is transported, dehydrogenating the first hydrogenated hydrocarbon cut to form hydrogen gas and a first dehydrogenated hydrocarbon cut; and at the additional hydrocarbon processing facility to which the second hydrogenated hydrocarbon cut is transported, dehydrogenating the second hydrogenated hydrocarbon cut to form hydrogen gas and a second dehydrogenated hydrocarbon cut.

According to one or more embodiments, a method of transporting hydrogen may comprise: at a first hydrocarbon processing facility, in a catalytic hydroprocessing reactor, hydrocracking a hydrocarbon feed comprising naphtha in the presence of hydrogen gas to form a hydrocracked effluent, wherein the hydrocracked effluent has a greater ratio of hydrogen to carbon than the hydrocarbon feed; at the first hydrocarbon processing facility, separating the hydrocracked effluent into at least a first hydrogenated hydrocarbon stream and a second hydrogenated hydrocarbon stream; transporting the first hydrogenated hydrocarbon stream and the second hydrogenated hydrocarbon stream from the first hydrocarbon processing facility to one or more additional hydrocarbon processing facilities, wherein the first hydrocarbon processing facility is at least 100 km apart from each additional hydrocarbon processing facility; at the additional hydrocarbon processing facility where the first hydrogenated hydrocarbon stream is transported, dehydrogenating the first hydrogenated hydrocarbon stream to form hydrogen gas and a first dehydrogenated hydrocarbon stream; and at the additional hydrocarbon processing facility where the second hydrogenated hydrocarbon stream is transported, dehydrogenating the second hydrogenated hydrocarbon stream to form hydrogen gas and a second dehydrogenated hydrocarbon stream.

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a diagram of a system for transporting hydrogen, according to one or more embodiments described in this disclosure;

FIG. 2 schematically depicts another diagram of a system for transporting hydrogen, according to one or more embodiments described in this disclosure;

FIG. 3 schematically depicts another diagram of a system for transporting hydrogen, according to one or more embodiments described in this disclosure; and

FIG. 4 schematically depicts another diagram of a system for transporting hydrogen, according to one or more embodiments described in this disclosure.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. However, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component. It should be understood that arrows in the relevant figures are not indicative of necessary or essential steps.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the streams signified by an arrow may be transported between the system components, such as if a slip stream is present.

It should be understood that a stream or cut may be named for a major component. Such a stream or cut may comprise a majority of the named component, such as at least 50 wt. %, at least 60 wt. %, at least 70 wt. %, at least 80 wt. %, at least 90 wt. %, at least 95 wt. %, at least 97 wt. %, at least 99 wt. %, at least 99.9 wt. %, at least 99.99 wt. %, or even 100 wt. % of the named component, on the basis of the total weight of the respective stream or cut. For example, a hydrogenated C₂ stream or a hydrogenated C₂ cut may comprise at least 50 wt. % of ethane, such as at least 60 wt. %, at least 70 wt. %, at least 80 wt. %, at least 90 wt. %, at least 95 wt. %, at least 97 wt. %, at least 99 wt. %, at least 99.9 wt. %, at least 99.99 wt. %, or even 100 wt. % of ethane, on the basis of the respective hydrogenated C₂ stream or hydrogenated C₂ cut.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

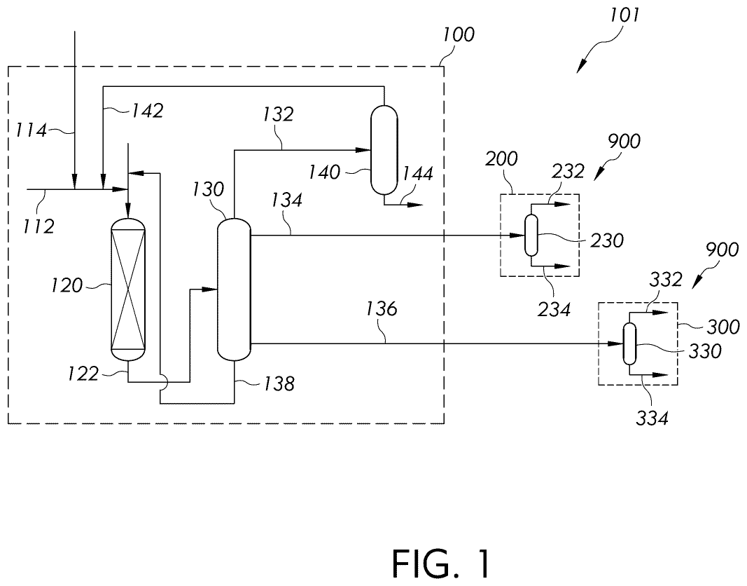

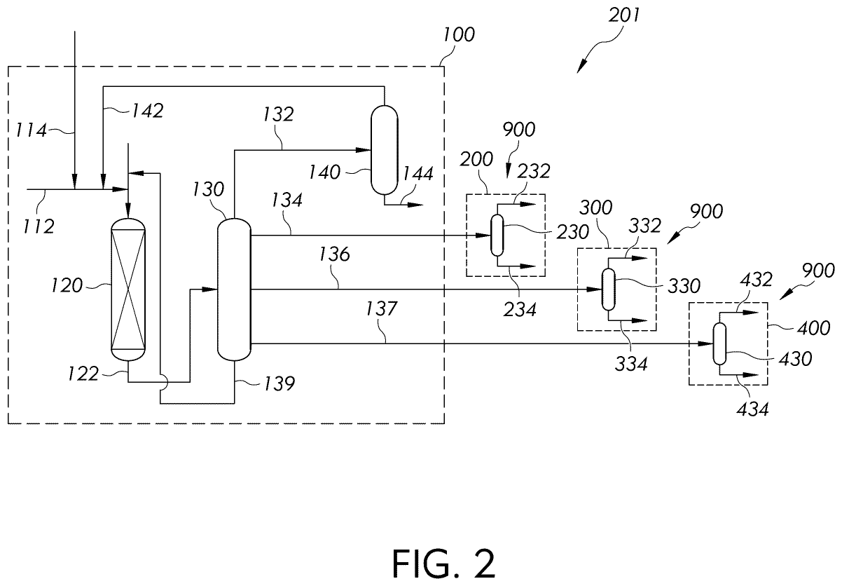

One or more embodiments of the present disclosure relate to methods for transporting hydrogen gas from one geographic region to another. In general, these methods are described herein in the context of one or more systems, shown in the drawings. As is discussed herein, the hydrogen transport systems utilize methods that may transport hydrogen by reacting hydrogen with hydrocarbon feeds to produce hydrocracked effluent, separating the hydrocracked effluent into one or more hydrogenated hydrocarbon cuts, then transporting the hydrogen in the form of the hydrogenated hydrocarbon cuts derived from the hydrocracked effluents, and then releasing the stored hydrogen by dehydrogenation. The embodiments of FIGS. 1-4 are similar or identical in many ways, respectively, but include differences as described herein. Description of the embodiments of FIGS. 1-4 may generally apply to the embodiments of the other figures, as would be understood by those skilled in the art. For example, concepts disclosed herein applicable to FIG. 1 may be equally applicable to FIG. 2, and vice versa, even if not explicitly stated as such herein.

As used in this disclosure, a “catalyst” refers to any substance which increases the rate of a specific chemical reaction. Catalysts described in this disclosure may be utilized to promote various reactions, such as, but not limited to, hydrocracking and dehydrogenation reactions. As used in this disclosure, a “hydrocracking catalyst” increases the rate of a hydrocracking reaction. As used in this disclosure, a “dehydrogenation catalyst” increases the rate of a dehydrogenation reaction. The methods described herein should not necessarily be limited by specific catalytic materials unless explicitly stated as such.

As used in this disclosure, a “separation unit” refers to any separation device or system of separation devices that at least partially separates one or more chemicals that are mixed in a process stream from one another. For example, a separation unit may selectively separate differing chemical species, phases, or sized material from one another, forming one or more chemical fractions. Examples of separation units include, without limitation, distillation columns, flash drums, knock-out drums, knock-out pots, centrifuges, cyclones, filtration devices, traps, scrubbers, expansion devices, membranes, solvent extraction devices, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation.

As used in this disclosure, “cracking” refers to a chemical reaction where a molecule having carbon-carbon bonds is broken into more than one molecule by the breaking of one or more of the carbon-carbon bonds; where a compound including a cyclic moiety, such as an aromatic, is converted to a compound that does not include a cyclic moiety; or where a molecule having carbon-carbon double bonds are reduced to carbon-carbon single bonds. Some catalysts may have multiple forms of catalytic activity, and calling a catalyst by one particular function does not render that catalyst incapable of being catalytically active for other functionality. In general, “hydrocracking” refers to cracking in the presence of hydrogen.

Now referring to FIG. 1, a hydrogen transport system 101 is depicted. The hydrogen transport system 101 may include at least a first hydrocarbon processing facility 100 and one or more additional hydrocarbon processing facilities 900, such as a second hydrocarbon processing facility 200 and a third hydrocarbon processing facility 300, where the first hydrocarbon processing facility 100 and the one or more additional hydrocarbon processing facilities 900 are in different geographic locations, as described herein. The first hydrocarbon processing facility 100 may comprise a first catalytic hydroprocessing reactor 120 (such as a hydrocracker)and a separation unit 130 and the one or more additional hydrocarbon processing facilities 900 may each comprise a dehydrogenation unit. These system components and their various arrangements will be described in detail herein.

In general, a single hydrocarbon processing facility, such as the first hydrocarbon processing facility 100, a second hydrocarbon processing facility 200, and a third hydrocarbon processing facility 300, each may be a processing facility that is only locally integrated with other processing facilities, and generally refers to an integrated complex capable of transforming its respective hydrocarbon feedstock into its respective products. For example, a single hydrocarbon processing facility may be under the control of a single entity, such as a company. In embodiments, each of the first hydrocarbon processing facility 100 and the one or more additional hydrocarbon processing facilities 900 may independently be oil refineries. For example, the first hydrocarbon processing facility 100 and the one or more additional hydrocarbon processing facilities 900 may be oil refineries, respectively, that are in different geographic regions, such as different states, countries, counties, provinces, continents, etc.

The first hydrocarbon processing facility 100 and the one or more additional hydrocarbon processing facilities 900 (e.g., the second hydrocarbon processing facility 200 and the third hydrocarbon processing facility 300) may be separate from one another and in different geographic regions. For example, the first hydrocarbon processing facility 100 and the one or more additional hydrocarbon processing facilities 900 may be at least 100 km apart from one another, such as at least 200 km apart from one another, at least 500 km apart from one another, or at least 1000 km apart from one another.

The physical distance between the first hydrocarbon processing facility 100 and the one or more additional hydrocarbon processing facilities 900 may make conventional transportation of hydrogen between the first hydrocarbon processing facility 100 and the one or more additional hydrocarbon processing facilities 900 difficult and/or costly. Use of the present methods and systems may allow cheaper and more efficient transport of hydrogen between the first hydrocarbon processing facility 100 and the one or more additional hydrocarbon processing facilities 900, thereby allowing an operator to take advantage of cheaper and/or renewable sources of electricity available near the first hydrocarbon processing facility 100 to form hydrogen. In some embodiments, the first hydrocarbon processing facility 100 and the one or more additional hydrocarbon processing facilities 900 may be located at different latitudes, which may allow the operator to take advantage of variations in energy production, such as the increased production of electricity of a given solar panel when placed closer to the equator.

Still referring to FIG. 1, in one or more embodiments, a hydrocarbon feed stream 112 may be utilized in hydrogen transport system 101 and passed to a catalytic hydroprocessing reactor 120 (such as a hydrocracker). The hydrocarbon feed stream 112 may comprise a distillate fraction (e.g., a crude oil distillate fraction) boiling in the naphtha range (e.g., light naphtha, heavy naphtha, or both). In embodiments, the hydrocarbon feed stream 112 (such as a hydrocarbon feed stream comprising light naphtha or both light and heavy naphtha) may have an initial boiling point of (IBP) of from 20° C. to 50° C., such as from 20° C. to 30° C., from 30° C. to 40° C., from 40° C. to 50° C., from 25° C. to 35° C., or any combination of one or more of these ranges. The hydrocarbon feed stream 112 (such as a hydrocarbon feed stream comprising light naphtha) may have a final boiling point (FBP) of from 70° C. to 110° C., such as from 70° C. to 80° C., from 80° C. to 90° C., from 90° C. to 100° C., from 100° C. to 110° C., or any combination of one or more of these ranges. In embodiments, the hydrocarbon feed stream 112 (such as a hydrocarbon feed stream comprising heavy naphtha) may have an initial boiling point of (IBP) of from 80° C. to 100° C., such as from 85° C. to 90° C., from 90° C. to 95° C., from 95° C. to 100° C., from 88° C. to 92° C., or any combination of one or more of these ranges. The hydrocarbon feed stream 112 (such as a hydrocarbon feed stream comprising heavy naphtha or both light and heavy naphtha) may have a final boiling point (FBP) of from 150° C. to 220° C., such as from 150° C. to 160° C., from 160° C. to 170° C., from 170° C. to 180° C., from 180° C. to 190° C., from 190° C. to 220° C., from 200° C. to 220° C., from 210° C. to 220° C., from 195° C. to 205° C., or any combination of one or more of these ranges.

According to one or more embodiments, at the first hydrocarbon processing facility 100, hydrogen gas and the hydrocarbon feed stream 112 may be passed to the first catalytic hydroprocessing reactor 120 (such as a hydrocracker). The hydrogen gas may comprise make-up hydrogen gas stream 114, and optionally, hydrogen gas recycle stream 142, as discussed herein in detail. The make-up hydrogen gas stream 114 and hydrogen gas recycle stream 142 may be combined before being introduced to the first catalytic hydroprocessing reactor 120. Alternatively, the make-up hydrogen gas stream 114 and hydrogen gas recycle stream 142 may each be introduced to the first catalytic hydroprocessing reactor 120 separately and combined therein. Similarly, the hydrogen gas from make-up hydrogen gas stream 114, hydrogen gas recycle stream 142, or both may be introduced to the first catalytic hydroprocessing reactor 120 directly, and combined therein or may be mixed with hydrocarbon feed stream 112 and the combined stream fed to the first catalytic hydroprocessing reactor 120. Make-up hydrogen gas stream 114 may comprise hydrogen produced from hydrocarbons, hydrogen produced from renewable sources (hydrogen produced from water electrolysis using electricity produced from sources other than the combustion of hydrocarbons), or both. In the first catalytic hydroprocessing reactor 120, at least a portion of the hydrogen gas and the hydrocarbon feed stream 112 may be converted to the hydrocracked effluent 122.

The first catalytic hydroprocessing reactor 120 may contact the hydrocarbon feed stream 112 with hydrogen gas and a hydrocracking catalyst to form the hydrocracked effluent 122. In general, a catalytic hydroprocessing reactor refers to any reactor that utilizes a catalyst to change the composition of the hydrocarbon feed, in the presence of hydrogen, for example to reduce the average carbon chain length of the hydrocarbons by cracking, among other possible reactions. The catalytic hydroprocessing reactor 120, such as a naphtha or vacuum gas oil hydrocracker, may be operated at a temperature of from 300° C. to 450° C., and with a liquid hourly space velocity (LHSV) of 0.3 to 2.0 h⁻¹. The catalytic hydroprocessing reactor 120 may be a fixed bed reactor, a slurry bed reactor, or an ebullated bed reactor. Typically, a slurry bed reactor may be operated at a temperature of from 400° C. to 460° C. and a pressure of at least 150 bar. Typically, a fixed bed or an ebullated bed reactor may be operated at a temperature of from 350° C. to 600° C. and a pressure of from 10 to 140 bar. Typically, a fixed bed or an ebullated bed reactor may be operated with a hydrocracking catalyst which may comprise Ni/Mo or Ni/W metals, however, the use of other metals such as Pd, Pt, Ir, Rh, Co, Ni, and the like are also contemplated. The metals may be supported on a zeolite, such as ZSM-5, ultra-stable Y (USY)-zeolite or Beta-zeolite. Generally, the ZSM-5 catalyst support may be suitable for use with at least naphtha feedstocks. Typically, a slurry bed reactor may be operated with a hydrocracking catalyst which may comprise metal sulfides (such as MoS₂). Typically a hydrocracking catalyst in a fixed-bed reactor may comprise particles from 1.2 mm to 3.0 mm in diameter, a hydrocracking catalyst in an ebullated bed reactor may comprise particles about less than 1 mm in diameter, and a hydrocracking catalyst in a slurry bed reactor may comprise particles with diameters in the micron range.

The hydrocracked effluent 122 may have a greater ratio of hydrogen to carbon than the hydrocarbon feed stream 112. For example, the degree of saturation of the hydrocarbons in the hydrocracked effluent 122 may be higher than the degree of saturation in the hydrocarbon feed stream 112, the average molecular weight of the hydrocarbons in the hydrocracked effluent 122 may be lower than the average molecular weight of the hydrocarbons in the hydrocarbon feed stream 112, or both. Thus, hydrogen atoms from hydrogen gas are incorporated into the hydrocarbons in the hydrocracked effluent 122. The hydrocracked effluent 122 may comprise light gas, light naphtha, and/or heavy naphtha.

Still referring to FIG. 1, the hydrocracked effluent 122 may be passed to a separation unit 130 to separate the hydrocracked effluent 122 into its constituent gasses. The separation unit 130 may separate the hydrocracked effluent 122 into at least a first hydrogenated hydrocarbon stream 134 (such as a hydrogenated C₂ stream) and a second hydrogenated hydrocarbon stream 136 (such as a hydrogenated C₃ stream). The separation unit 130 may further separate the hydrocracked effluent 122 into a C₁+H₂ stream 132, a hydrogenated C₄₊ stream 138, or both. The separation unit 130 may be any suitable separation unit, such as, and without limitation, a series of flash vessels or a fractionator/distillation column that separates feedstock based on the boiling point.

The C₁+H₂ stream 132 may comprise a hydrogenated C₁ cut comprising C₁ hydrocarbons (e.g., methane). The C₁+H₂ stream 132 may further comprise hydrogen gas. In embodiments, the C₁+H₂ stream 132 may comprise at least 50 wt. %, at least 60 wt. %, at least 70 wt. %, at least 80 wt. %, at least 90 wt. %, at least 95 wt. %, at least 99 wt. %, or even at least 99.9 wt. % of the combined weight of C₁ hydrocarbons and hydrogen gas, on the basis of the total weight of C₁+H₂ stream 132.

The C₁+H₂ stream 132 may passed to first facility hydrogen gas separation unit 140 to separate a hydrogen gas recycle stream 142 and a hydrogenated C₁ stream 144 from the first facility hydrogen gas separation unit 140. The hydrogen gas recycle stream 142 may be passed to the catalytic hydroprocessing reactor 120, either alone or in combination with make-up hydrogen gas stream 114.

The first hydrogenated hydrocarbon stream 134 may comprise a first hydrogenated hydrocarbon cut. The first hydrogenated hydrocarbon stream may be a hydrogenated C₂ stream and the first hydrogenated hydrocarbon cut may be a hydrogenated C₂ cut. In embodiments, the first hydrogenated hydrocarbon stream 134 may comprise at least 50 wt. %, at least 60 wt. %, at least 70 wt. %, at least 80 wt. %, at least 90 wt. %, at least 95 wt. %, at least 99 wt. %, or even at least 99.9 wt. % of saturated C₂ hydrocarbons (e.g., ethane), on the basis of the total weight of first hydrogenated hydrocarbon stream 134. The hydrocarbons of the first hydrogenated hydrocarbon stream 134 and the first hydrogenated hydrocarbon cut may be transported from first hydrocarbon processing facility 100 to one or more additional hydrocarbon processing facilities 900, such as second hydrocarbon processing facility 200.

In embodiments, transporting the first hydrogenated hydrocarbon cut and the first hydrogenated hydrocarbon stream 134 to the one or more additional hydrocarbon processing facilities 900 (e.g., the second hydrocarbon processing facility 200) may comprise transporting the first hydrogenated hydrocarbon cut and the first hydrogenated hydrocarbon stream 134 from the first hydrocarbon processing facility 100 to the one or more additional hydrocarbon processing facilities 900 (e.g., the second hydrocarbon processing facility 200) by tanker truck, train, ship, pipeline, or the like. In embodiments, the hydrocarbons may be transported from the first hydrocarbon processing facility 100 to the one or more additional hydrocarbon processing facilities 900 by tanker truck, train, and/or ship. A time of at least 2 weeks, such as at least 1 month, at least 2 months, or at least 6 months, may pass between hydrocracking the hydrocarbon feed stream 112 and dehydrogenating the first hydrogenated hydrocarbon cut and the first hydrogenated hydrocarbon stream 134. The transportation step may include storing the hydrocarbons at the first hydrocarbon processing facility 100, the one or more additional hydrocarbon processing facilities 900, at an intermediate storage or processing facility (not shown in the figures), or in the transportation vessel itself. The temporal difference between the hydrocracking and dehydrogenating steps may allow the operator to store intermittent electricity in the form of hydrogen for use during times of higher demand, such as storing summer solar power for winter.

At the one or more additional hydrocarbon processing facilities 900, such as the second hydrocarbon processing facility 200, the first hydrogenated hydrocarbon cut and the first hydrogenated hydrocarbon stream 134 may be dehydrogenated in a second hydrocarbon processing facility dehydrogenation unit 230. Dehydrogenating a stream refers to the process of removing hydrogen atoms from a hydrocarbon molecule. Dehydrogenation produces hydrogen gas, which may be separated to form a hydrogen gas stream 232. The hydrogen gas stream 232 may be stored and sent to uses external to the refinery or may be sent to a refinery process unit. Suitable refinery process units include, for example, hydrotreaters, hydrocrackers, hydroprocessors, isomerization units, and catalytic reformers. Dehydrogenation also produces first dehydrogenated hydrocarbon stream 234, which may comprise valuable precursor chemicals.

One suitable second hydrocarbon processing facility dehydrogenation unit 230 is a steam cracker. Steam cracking refers to the process of cracking and dehydrogenating hydrocarbons by contacting the hydrocarbons with steam. Generally, steam cracking produces both cracked hydrocarbons and hydrogen. The steam cracker may include a convection zone and a pyrolysis zone downstream of the convection zone. The hydrocarbons may pass into the convection zone with steam. In the convection zone, the hydrocarbons may be pre-heated to a desired temperature, such as from 400° C. to 650° C. The pre-heated hydrocarbons may then be passed to the pyrolysis zone, where they may be steam-cracked. According to one or more embodiments, the pyrolysis zone may operate at a temperature of from 700° C. to 900° C. The pyrolysis zone may operate with a residence time of from 0.05 seconds to 2 seconds. The mass ratio of steam to hydrocarbons may be from about 0.3:1 to about 2:1. Generally, steam cracking occurs in the absence of a catalyst.

First dehydrogenated hydrocarbon stream 234 may be dehydrogenated C₂ stream comprising a dehydrogenated C₂ cut, comprising ethylene. The first dehydrogenated hydrocarbon stream 234 may comprise at least 75 wt. %, at least 80 wt. %, at least 90 wt. %, at least 95 wt. %, at least 99 wt. %, at least 99.9 wt. %, at least 99.99 wt. %, at least 99.999 wt. %, or even at least 99.9999 wt. % of ethylene, on the basis of the total weight of first dehydrogenated hydrocarbon stream 234.

Hydrogen gas stream 232 may comprise at least 75 wt. %, at least 80 wt. %, at least 90 wt. %, at least 95 wt. %, at least 99 wt. %, at least 99.9 wt. %, at least 99.99 wt. %, at least 99.999 wt. %, or even at least 99.9999 wt. % of hydrogen gas, on the basis of the total weight of hydrogen gas stream 232.

The second hydrogenated hydrocarbon stream 136 may comprise a second hydrogenated hydrocarbon cut. The second hydrogenated hydrocarbon stream 136 may be a hydrogenated C₃ stream comprising a hydrogenated C₃ cut. In embodiments, the second hydrogenated hydrocarbon stream 136 may comprise at least 50 wt. %, at least 60 wt. %, at least 70 wt. %, at least 80 wt. %, at least 90 wt. %, at least 95 wt. %, at least 99 wt. %, or even at least 99.9 wt. % of saturated C₃ hydrocarbons (e.g., propane), on the basis of the total weight of second hydrogenated hydrocarbon stream 136. The second hydrogenated hydrocarbon stream 136 may be transported from first hydrocarbon processing facility 100 to one or more additional hydrocarbon processing facilities 900, such as third hydrocarbon processing facility 300. Transporting the second hydrogenated hydrocarbon stream 136 and/or second hydrogenated hydrocarbon cut to the one or more additional hydrocarbon processing facilities 900 (e.g., the third hydrocarbon processing facility 300) may be as described herein for transporting the first hydrogenated hydrocarbon stream 134 and first hydrogenated hydrocarbon cut.

At the one or more additional hydrocarbon processing facilities 900, such as the third hydrocarbon processing facility 300, the hydrocarbons of the second hydrogenated hydrocarbon stream 136 and the second hydrogenated hydrocarbon cut may be dehydrogenated in a third hydrocarbon processing facility dehydrogenation unit 330, thereby producing hydrogen gas stream 332 and second dehydrogenated hydrocarbon stream 334. Second dehydrogenated hydrocarbon stream 334 may comprise valuable precursor chemicals (e.g. propylene).

One suitable third hydrocarbon processing facility dehydrogenation unit 330 is a propane dehydrogenation unit. Processes for the dehydrogenation of propane include oxidative hydrogenation processes and non-oxidative dehydrogenation processes. In an oxidative dehydrogenation process, the process heat is provided by partial oxidation of the lower alkane(s) in the feed. In a non-oxidative dehydrogenation process, the process heat for the endothermic dehydrogenation reaction is provided by external heat sources such as hot flue gases obtained by burning of fuel gas or steam.

In embodiments, the propane dehydrogenation unit may operate at a temperature of from 300° C. to 800° C., such as from 300° C. to 400° C., from 400° C. to 500° C., from 500° C. to 600° C., from 600° C. to 700° C., from 700° C. to 800° C., or any combination thereof. The propane dehydrogenation unit may also operate at a pressure of from 0.001 MPa to 1 MPa. Without being bound by any particular theory, it is believed that since the dehydrogenation of hydrocarbons is an endothermic reaction and conversion levels are limited by chemical equilibrium, it may be desirable to operate at relatively high temperatures and relatively low hydrogen partial pressures in order to achieve greater conversion.

In embodiments, the propane dehydrogenation unit may also include a catalyst system for conversion of hydrocarbons. The catalyst system may include a dehydrogenation catalyst, such as, an alumina, silica, zirconia, or amorphous silica-alumina support material, one or more alkali or alkaline earth metals, and/or one or more platinum group metals. In some embodiments, the dehydrogenation catalyst may comprise Pt and/or Cr with alkali or alkaline earth metals and an alumina support. Dehydrogenating propane, butane, or both may further include contacting the propane, butane, or both hydrocarbons with the catalyst system to dehydrogenate at least a portion of the propane into the propylene.

Second dehydrogenated hydrocarbon stream 334 may comprise a second dehydrogenated hydrocarbon cut. The second dehydrogenated hydrocarbon stream 333 may be a dehydrogenated C₃ stream comprising a dehydrogenated C₃ cut, comprising propylene. The second dehydrogenated hydrocarbon stream 334 may comprise at least 75 wt. %, at least 80 wt. %, at least 90 wt. %, at least 95 wt. %, at least 99 wt. %, at least 99.9 wt. %, at least 99.99 wt. %, at least 99.999 wt. %, or even at least 99.9999 wt. % of propylene, on the basis of the total weight of second dehydrogenated hydrocarbon stream 334.

Hydrogen gas stream 332 may comprise at least 75 wt. %, at least 80 wt. %, at least 90 wt. %, at least 95 wt. %, at least 99 wt. %, at least 99.9 wt. %, at least 99.99 wt. %, at least 99.999 wt. %, or even at least 99.9999 wt. % of hydrogen gas, on the basis of the total weight of hydrogen gas stream 332.

Still referring to FIG. 1, the separation unit 130 may optionally produce hydrogenated C₄₊ stream 138 comprising a hydrogenated C₄₊ cut. Hydrogenated C₄₊ stream 138 may comprise hydrocarbons having at least 4 carbon atoms. In embodiments, hydrogenated C₄₊ stream 138 may comprise at least 80 wt. %, at least 90 wt. %, at least 95 wt. %, or at least 99 wt. % of hydrocarbons having at least 4 carbon atoms, such as from 4-10 carbon atoms. In embodiments, at least 50 wt. %, at least 60 wt. %, at least 70 wt. %, at least 80 wt. %, at least 90 wt. %, or at least 95 wt. % of the hydrocarbons in the hydrogenated C₄₊ stream 138 may be saturated. In embodiments, the hydrogenated C₄₊ stream 138 may be passed back to the first catalytic hydroprocessing reactor 120 and processed with the hydrocarbon feed stream 112.

Referring now to FIG. 2, another hydrogen transport system 201 is depicted. The hydrogen transport system 201 may be similar or identical to the hydrogen transport system 101 of FIG. 1, except where described otherwise. In particular, the separation unit 130 of hydrogen transport system 201 may form hydrogenated C₄ stream 137 and hydrogenated C₅₊ stream 139 instead of hydrogenated C₄₊ stream 138.

The hydrogenated C₅₊ stream 139 may comprise a hydrogenated C₅₊ cut. Hydrogenated C₅₊ stream 139 may comprise hydrocarbons having at least 5 carbon atoms. In embodiments, hydrogenated C₅₊ stream 139 may comprise at least 80 wt. %, at least 90 wt. %, at least 95 wt. %, or at least 99 wt. % of hydrocarbons having at least 5 carbon atoms, such as from 5-10 carbon atoms. In embodiments, at least 50 wt. %, at least 60 wt. %, at least 70 wt. %, at least 80 wt. %, at least 90 wt. %, or at least 95 wt. % of the hydrocarbons in the hydrogenated C₅₊ stream 139 may be saturated. In embodiments, the hydrogenated C₅₊ stream 139 may be passed back to the first catalytic hydroprocessing reactor 120 and processed with the hydrocarbon feed stream 112.

The hydrogenated C₄ stream 137 may comprise a hydrogenated C₄ cut. In embodiments, the hydrogenated C₄ stream 137 may comprise at least 50 wt. %, at least 60 wt. %, at least 70 wt. %, at least 80 wt. %, at least 90 wt. %, at least 95 wt. %, at least 99 wt. %, or even at least 99.9 wt. % of saturated C₄ hydrocarbons (e.g., butane), on the basis of the total weight of hydrogenated C₄ stream 137. The hydrogenated C₄ stream 137 may be transported from first hydrocarbon processing facility 100 to one or more additional hydrocarbon processing facilities 900, such as fourth hydrocarbon processing facility 400. In some embodiments, fourth hydrocarbon processing facility 400 may be the same facility as any of the other additional hydrocarbon processing facilities 900, such as second hydrocarbon processing facility 200 or third hydrocarbon processing facility 300. Transporting the hydrogenated C₄ cut to the one or more additional hydrocarbon processing facilities 900 (e.g., the fourth hydrocarbon processing facility 400) may be as described herein for transporting the hydrogenated C₂ cut.

At the one or more additional hydrocarbon processing facilities 900, such as the fourth hydrocarbon processing facility 400, the hydrogenated C₄ cut may be dehydrogenated in a fourth hydrocarbon processing facility dehydrogenation unit 430, thereby producing hydrogen gas stream 432 and dehydrogenated C₄ stream 434. Dehydrogenated C₄ stream 434 may comprise valuable precursor chemicals (e.g., butylene).

One suitable fourth hydrocarbon processing facility dehydrogenation unit 430 is a butane dehydrogenation unit. Processes for the dehydrogenation of butane include oxidative hydrogenation processes and non-oxidative dehydrogenation processes. In an oxidative dehydrogenation process, the process heat is provided by partial oxidation of the lower alkane(s) in the feed. In a non-oxidative dehydrogenation process, the process heat for the endothermic dehydrogenation reaction is provided by external heat sources such as hot flue gases obtained by burning of fuel gas or steam.

In embodiments, the butane dehydrogenation unit may operate at a temperature of from 300° C. to 800° C., such as from 300° C. to 400° C., from 400° C. to 500° C., from 500° C. to 600° C., from 600° C. to 700° C., from 700° C. to 800° C., or any combinations thereof. The butane dehydrogenation unit may also operate at a pressure of from 0.001 MPa to 1 MPa. Without being bound by any particular theory, it is believed that since the dehydrogenation of hydrocarbons is an endothermic reaction and conversion levels are limited by chemical equilibrium, it may be desirable to operate at relatively high temperatures and relatively low hydrogen partial pressures in order to achieve greater conversion.

In embodiments, the butane dehydrogenation unit may also include a catalyst system for conversion of hydrocarbons. The catalyst system may include a dehydrogenation catalyst, such as, an alumina, silica, zirconia, or amorphous silica-alumina support material, one or more alkali or alkaline earth metals, and/or one or more platinum group metals. In some embodiments, the dehydrogenation catalyst may comprise Pt and/or Cr with alkali or alkaline earth metals and an alumina support. Dehydrogenating butane may further include contacting the butane with the catalyst system to dehydrogenate at least a portion of the butane into the butylene.

Dehydrogenated C₄ stream 434 may comprise a dehydrogenated C₄ cut, comprising dehydrogenated C₄ hydrocarbons such as butylene. The dehydrogenated C₄ stream 434 may comprise at least 75 wt. %, at least 80 wt. %, at least 90 wt. %, at least 95 wt. %, at least 99 wt. %, at least 99.9 wt. %, at least 99.99 wt. %, at least 99.999 wt. %, or even at least 99.9999 wt. % of dehydrogenated C₄ hydrocarbons, on the basis of the total weight of dehydrogenated C₄ stream 434.

It should be understood that in some embodiments, more than one of first hydrogenated hydrocarbon stream 134, second hydrogenated hydrocarbon stream 136, and hydrogenated C₄ stream 137 may be processed in the same dehydrogenation unit. For example, both first hydrogenated hydrocarbon stream 134 and second hydrogenated hydrocarbon stream 136; first hydrogenated hydrocarbon stream 134 and hydrogenated C₄ stream 137; second hydrogenated hydrocarbon stream 136 and hydrogenated C₄ stream 137; or hydrogenated C₂ stream 134, hydrogenated C₃ stream 136, and hydrogenated C₄ stream 137 may be processed in the same dehydrogenation unit.

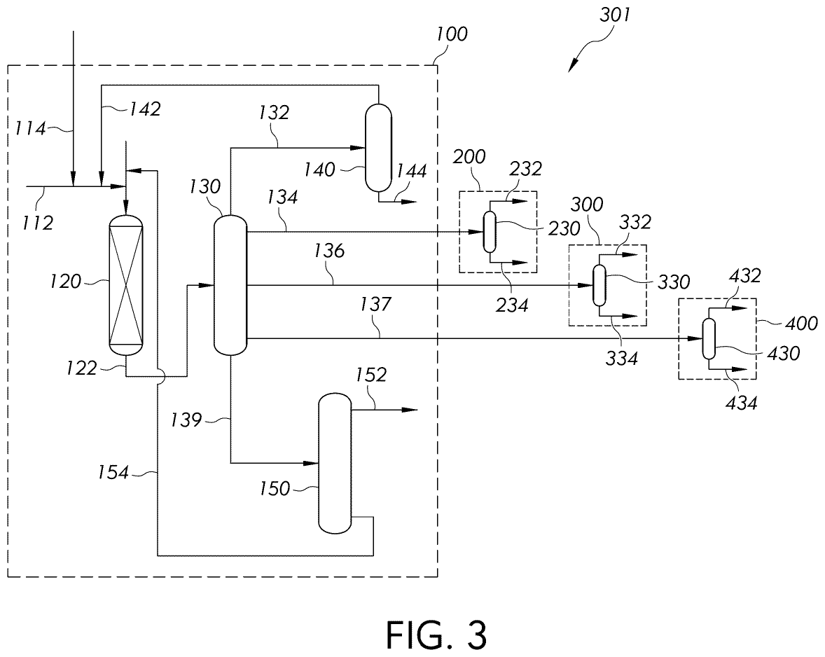

Referring now to FIG. 3, another hydrogen transport system 301 is depicted. The hydrogen transport system 301 may be similar or identical to the hydrogen transport system 201 of FIG. 2, except where described otherwise. In particular, the hydrogenated C₅₊ stream 139 may be passed to aromatic separation unit 150, thereby producing aromatic stream 152 comprising an aromatic cut comprising aromatic compounds and non-aromatic stream 154 comprising a non-aromatic cut. The non-aromatic stream 154 may be passed back to the first catalytic hydroprocessing reactor 120, where it may be hydrocracked with the hydrocarbon feed stream 112.

The aromatic separation unit 150 may be any separation unit capable of removing aromatic compounds from the hydrocracked effluent 122 (e.g., from the from a hydrogenated C₅₊ cut separated from the 122). In some embodiments, the aromatic separation unit 150 may be an extractive separation unit or a membrane separation unit. In an extractive separation unit, a liquid-liquid extraction is performed to remove one or more compounds (such as aromatic compounds) from the bulk feedstock into a solvent. The solvent may then be separated in any suitable separation unit, such as, and without limitation, a series of flash vessels or a fractionator/distillation column that separates feedstock based on the boiling point, to remove the separated compounds. Generally, in a membrane separation unit, a polar solvent is separated from the bulk feedstock by a membrane to remove one or more compounds from the bulk feedstock into the polar solvent. The solvent and the remaining feedstock may then be separated in any suitable separation unit, such as, and without limitation, a series of flash vessels or a fractionator/distillation column that separates feedstock based on the boiling point, to remove the target compounds. The aromatic separation unit 150 may include any suitable separation unit, such as, and without limitation, a series of flash vessels or a fractionator/distillation column that separates feedstock based on the boiling point. In embodiments, the aromatic separation unit 150 may comprise an aromatics complex.

In embodiments, aromatic stream 152 may comprise at least 50 wt. %, at least 60 wt. %, at least 70 wt. %, at least 80 wt. %, at least 90 wt. %, at least 95 wt. %, or even at least 99 wt. % of aromatic compounds, on the basis of the total weight of aromatic stream 152. In embodiments, the aromatic cut may comprise at least 50 wt. %, at least 60 wt. %, at least 70 wt. %, at least 80 wt. %, at least 90 wt. %, at least 95 wt. %, or even at least 99 wt. % of aromatic compounds, on the basis of the total weight of the aromatic cut.

In embodiments, the non-aromatic stream 154 may comprise at least 50 wt. %, at least 60 wt. %, at least 70 wt. %, at least 80 wt. %, at least 90 wt. %, at least 95 wt. %, or even at least 99 wt. % of non-aromatic compounds, on the basis of the total weight of non-aromatic stream 154. In embodiments, the non-aromatic cut may comprise at least 50 wt. %, at least 60 wt. %, at least 70 wt. %, at least 80 wt. %, at least 90 wt. %, at least 95 wt. %, or even at least 99 wt. % of non-aromatic compounds, on the basis of the total weight of the non-aromatic cut.

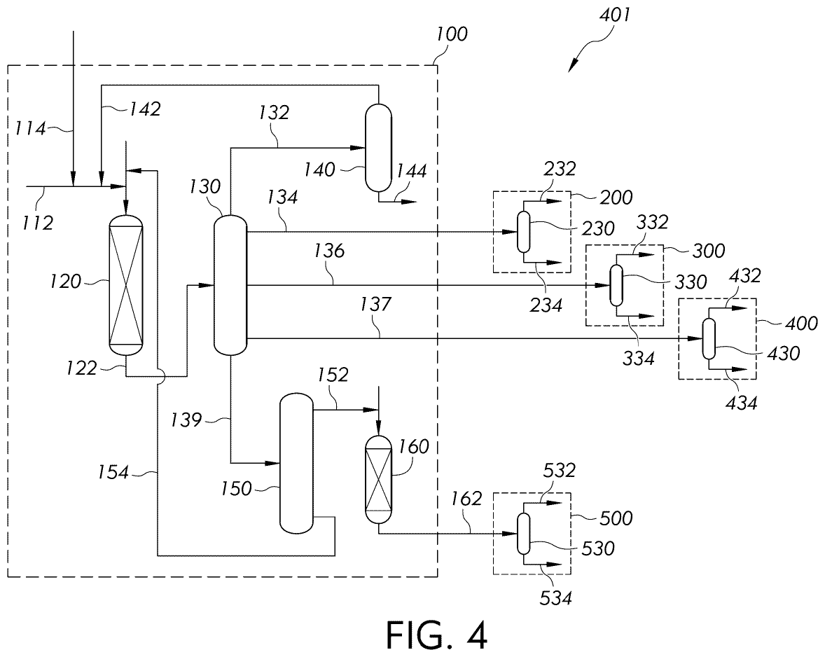

Referring now to FIG. 4, another hydrogen transport system 401 is depicted. The hydrogen transport system 401 may be similar or identical to the hydrogen transport system 301 of FIG. 3, except where described otherwise. In particular, the aromatic stream 152 and additional hydrogen may be passed to second catalytic hydroprocessing reactor 160, thereby forming a naphthene stream 162.

The second catalytic hydroprocessing reactor 160 may contact the aromatic stream 152 with hydrogen gas and a catalyst to form the naphthene stream 162. The second catalytic hydroprocessing reactor 160 may be operated at a temperature of from 200° C. to 400° C., and with a liquid hourly space velocity (LHSV) of 0.3 to 2.0 h⁻¹. The second catalytic hydroprocessing reactor 160 may be a fixed bed reactor, a slurry bed reactor, or an ebullated bed reactor. Typically, a fixed bed or an ebullated bed reactor may be operated with a catalyst which may comprise Group VIII metals. The metals may be in metallic or sulfide form. The use of other metals such as Pd, Pt, Ir, Rh, Co, Ni, and the like are also contemplated. Typically, a slurry bed reactor may be operated with a catalyst which may comprise metal sulfides (such as MoS₂). Typically a catalyst in a fixed-bed reactor may comprise particles from 1.2 mm to 3.0 mm in diameter, a catalyst in an ebullated bed reactor may comprise particles about less than 1 mm in diameter, and a hydrocracking catalyst.

Naphthene stream 162 may comprise a naphthene cut. The naphthene cut may comprise cycloalkanes. In embodiments, the naphthene cut, the naphthene stream 162, or both may comprise at least 50 wt. %, at least 60 wt. %, at least 70 wt. %, at least 80 wt. %, at least 90 wt. %, at least 95 wt. %, or even at least 99 wt. % of cycloalkanes, on the basis of the total weight of the respective naphthene cut or naphthene stream 162.

The naphthene cut, the naphthene stream 162, or both may be transported to one or more additional hydrocarbon processing facilities 900 (e.g., fifth hydrocarbon processing facility 500). Transporting the naphthene cut, the naphthene stream 162, or both to the one or more additional hydrocarbon processing facilities 900 (e.g., the fifth hydrocarbon processing facility 500) may be as described herein for transporting the hydrogenated C₂ cut.

At the one or more additional hydrocarbon processing facilities 900, such as the fifth hydrocarbon processing facility 500, the naphthene cut may be dehydrogenated in a fifth hydrocarbon processing facility dehydrogenation unit 530, thereby producing hydrogen gas stream 532 and additional aromatic stream 534. Additional aromatic stream 534 may comprise valuable precursor chemicals (e.g., benzene, toluene, and xylene).

One suitable fifth hydrocarbon processing facility dehydrogenation unit 530 is an aromatization unit, which functions to convert non-aromatic hydrocarbons to aromatic hydrocarbons. The aromatization unit may also produce significant amounts of hydrogen gas. The aromatization unit may contact the hydrocarbons with a catalyst, the catalyst may be a mono- or bi-functional metal catalyst (for instance, one or more of platinum, palladium, rhenium, tin, gallium, bismuth, or other metal catalysts), a halogen containing catalyst, a catalyst employing a crystalline or amorphous support that is mesoporous or microporous (for instance, an alumina, silica, or alumina silica support), or another type of catalyst that can maximize aromatics production. The aromatization unit may operate at a reaction temperature of from 50° C. to 700° C., such as from 50° C. to 100° C., from 100° C. to 150° C., from 150° C. to 200° C., from 200° C. to 250° C., from 250° C. to 300° C., from 300° C. to 350° C., from 350° C. to 400° C., from 400° C. to 450° C., from 450° C. to 500° C., from 500° C. to 550° C., from 550° C. to 600° C., from 600° C. to 650° C., from 650° C. to 700° C., from 400° C. to 600° C., or any combination of these ranges; a reaction pressure of from 1 bar to 50 bar, such as from 1 bar to 5 bar, from 5 bar to 10 bar, from 10 bar to 20 bar, from 20 bar to 30 bar, from 30 bar to 40 bar, from 40 bar to 50 bar, or any combination of these ranges; and a liquid hourly space velocity (LHSV) of from 0.5 h⁻¹ to 5 h⁻¹, such as from 0.5 h⁻¹ to 1 h⁻¹, from 1 h⁻¹ to 2 h⁻¹, from 2 h⁻¹ to 3 h⁻¹, from 3 h⁻¹ to 4 h⁻¹, from 4 h⁻¹ to 5 h⁻¹, or any combination of these ranges.

Processing the naphthene cut in the fifth hydrocarbon processing facility dehydrogenation unit 530 may produce hydrogen gas stream 532 and additional aromatic stream 534 comprising an aromatic cut. In embodiments, the additional aromatic stream 534, the aromatic cut, or both may comprise at least 50 wt. %, at least 60 wt. %, at least 70 wt. %, at least 80 wt. %, at least 90 wt. %, at least 95 wt. %, or at least 99 wt. % of aromatic compounds, on the basis of the total weight of the respective additional aromatic stream 534 or the aromatic cut. In embodiments, the hydrogen gas stream 532 may comprise at least 80 wt. %, at least 90 wt. %, at least 95 wt. %, at least 99 wt. %, at least 99.9 wt. %, at least 99.99 wt. %, at least 99.999 wt. %, or even at least 99.9999 wt. % of hydrogen gas, on the basis of the total weight of hydrogen gas stream 532.

Numerous aspects are presently disclosed herein, including Aspects 1-20.
Aspect 1 discloses a method of transporting hydrogen comprising: at a first hydrocarbon processing facility, in a catalytic hydroprocessing reactor, hydrocracking a hydrocarbon feed comprising naphtha in the presence of hydrogen gas to form a hydrocracked effluent, wherein the hydrocracked effluent has a greater ratio of hydrogen to carbon than the hydrocarbon feed; at the first hydrocarbon processing facility, separating the hydrocracked effluent into at least a first hydrogenated hydrocarbon cut and a second hydrogenated hydrocarbon cut; transporting the first hydrogenated hydrocarbon cut and the second hydrogenated hydrocarbon cut from the first hydrocarbon processing facility to one or more additional hydrocarbon processing facilities, wherein the first hydrocarbon processing facility and the one or more additional hydrocarbon processing facilities are at least 100 km apart from one another; at the additional hydrocarbon processing facility to which the first hydrogenated hydrocarbon cut is transported, dehydrogenating the first hydrogenated hydrocarbon cut to form hydrogen gas and a first dehydrogenated hydrocarbon cut; and at the additional hydrocarbon processing facility to which the second hydrogenated hydrocarbon cut is transported, dehydrogenating the second hydrogenated hydrocarbon cut to form hydrogen gas and a second dehydrogenated hydrocarbon cut.
Aspect 2, which includes aspect 1, discloses the first hydrogenated hydrocarbon cut is a hydrogenated C₂ cut, the first dehydrogenated hydrocarbon cut is a dehydrogenated C₂ cut, the second hydrogenated hydrocarbon cut is a hydrogenated C₃ cut, the second dehydrogenated hydrocarbon cut is a dehydrogenated C₃ cut.
Aspect 3, which includes either of aspects 1 or 2, discloses, the first hydrogenated hydrocarbon cut and the second hydrogenated hydrocarbon cut are transported to separate hydrocarbon processing facilities.
Aspect 4, which includes any one of aspects 1 to 2, discloses the first hydrogenated hydrocarbon cut and the second hydrogenated hydrocarbon cut are transported to the same hydrocarbon processing facility.
Aspect 5, which includes any of aspects 1 to 4, discloses further separating the hydrocracked effluent into a hydrogenated C₄₊ cut and passing the hydrogenated C₄₊ cut back to the catalytic hydroprocessing reactor.
Aspect 6, which includes any one of aspects 1-5. discloses: separating the hydrocracked effluent into a hydrogenated C₄ cut and a hydrogenated C₅₊ cut; transporting the hydrogenated C₄ cut to an additional hydrocarbon processing facility; and at the additional hydrocarbon processing facility, dehydrogenating the hydrogenated C₄ cut to form a dehydrogenated C₄ cut and hydrogen gas.
Aspect 7, which includes aspects 6, discloses that each of the hydrogenated C₂ cut, the hydrogenated C₃ cut, and the hydrogenated C₄ cut are transported to separate hydrocarbon processing facilities.
Aspect 8, which includes any one of aspects 6-7, discloses: separating the hydrogenated C₅₊ cut into an aromatic cut and a non-aromatic cut; and passing the non-aromatic cut back to the catalytic hydroprocessing reactor.
Aspect 9, which includes aspect 8, discloses: hydrogenating the aromatic cut to form a naphthene cut; transporting the naphthene cut to an additional hydrocarbon processing facility; and at the additional hydrocarbon processing facility, dehydrogenating the naphthene cut to form an additional hydrocarbon processing facility aromatic cut and hydrogen gas.
Aspect 10, which includes any one of aspects 1-9, discloses separating hydrogen gas from the hydrocracked effluent.
Aspect 11, which includes aspect 10, discloses passing the separated hydrogen gas back to the catalytic hydroprocessing reactor.
Aspect 12 discloses a method of transporting hydrogen comprising: at a first hydrocarbon processing facility, in a catalytic hydroprocessing reactor, hydrocracking a hydrocarbon feed comprising naphtha in the presence of hydrogen gas to form a hydrocracked effluent, wherein the hydrocracked effluent has a greater ratio of hydrogen to carbon than the hydrocarbon feed; at the first hydrocarbon processing facility, separating the hydrocracked effluent into at least a first hydrogenated hydrocarbon stream and a second hydrogenated hydrocarbon stream; transporting the first hydrogenated hydrocarbon stream and the second hydrogenated hydrocarbon stream from the first hydrocarbon processing facility to one or more additional hydrocarbon processing facilities, wherein the first hydrocarbon processing facility is at least 100 km apart from each additional hydrocarbon processing facility; at the additional hydrocarbon processing facility where the first hydrogenated hydrocarbon stream is transported, dehydrogenating the first hydrogenated hydrocarbon stream to form hydrogen gas and a first dehydrogenated hydrocarbon stream; and at the additional hydrocarbon processing facility where the second hydrogenated hydrocarbon stream is transported, dehydrogenating the second hydrogenated hydrocarbon stream to form hydrogen gas and a second dehydrogenated hydrocarbon stream.
Aspect 13, which includes aspect 12, discloses the first hydrogenated hydrocarbon stream is a hydrogenated C₂ stream, the first dehydrogenated hydrocarbon stream is a dehydrogenated C₂ stream, the second hydrogenated hydrocarbon stream is a hydrogenated C₃ stream, and the second dehydrogenated hydrocarbon stream is a dehydrogenated C₃ stream.
Aspect 14, which includes either of aspects 12 or 13, discloses the first hydrogenated hydrocarbon stream and the second hydrogenated hydrocarbon stream are transported to separate hydrocarbon processing facilities.
Aspect 15, which includes any one of aspects 12 to 14 discloses separating the hydrocracked effluent into a hydrogenated C₄₊ stream and recycling the hydrogenated C₄₊ stream back to the catalytic hydroprocessing reactor.
Aspect 16, which includes any one of aspects 12 to 14, discloses separating the hydrocracked effluent into a hydrogenated C₄ stream and a hydrogenated C₅₊ stream; transporting the hydrogenated C₄ stream to an additional hydrocarbon processing facility; and at the additional hydrocarbon processing facility to which the hydrogenated C₄ stream is transported, dehydrogenating the hydrogenated C₄ stream to form a dehydrogenated C₄ stream and hydrogen gas.
Aspect 17, which includes aspect 16, discloses separating the hydrogenated C₅₊ stream into an aromatic stream and a non-aromatic stream; and passing the non-aromatic stream back to the catalytic hydroprocessing reactor.
Aspect 18, which includes aspect 17, discloses hydrogenating the aromatic stream to form a naphthene stream; transporting the naphthene stream to an additional hydrocarbon processing facility; and at the additional hydrocarbon processing facility to which the naphthene stream is transported, dehydrogenating the naphthene stream to form an additional hydrocarbon processing facility aromatic stream and hydrogen gas.
Aspect 19, which includes any one of aspects 12 to 18, discloses separating hydrogen gas from the hydrocracked effluent.
Aspect 20, which includes aspect 19, discloses passing the separated hydrogen gas back to the catalytic hydroprocessing reactor.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It is also noted that recitations herein of “at least one” component, element, etc., should not be used to create an inference that the alternative use of the articles “a” or “an” should be limited to a single component, element, etc.

What is claimed is:

1. A method of transporting hydrogen comprises:
at a first hydrocarbon processing facility, in a catalytic hydroprocessing reactor, hydrocracking a hydrocarbon feed comprising naphtha in the presence of hydrogen gas to form a hydrocracked effluent, wherein the hydrocracked effluent has a greater ratio of hydrogen to carbon than the hydrocarbon feed;
at the first hydrocarbon processing facility, separating the hydrocracked effluent into at least a first hydrogenated hydrocarbon cut and a second hydrogenated hydrocarbon cut;
transporting the first hydrogenated hydrocarbon cut and the second hydrogenated hydrocarbon cut from the first hydrocarbon processing facility to one or more additional hydrocarbon processing facilities, wherein the first hydrocarbon processing facility and the one or more additional hydrocarbon processing facilities are at least 100 km apart from one another;
at the additional hydrocarbon processing facility to which the first hydrogenated hydrocarbon cut is transported, dehydrogenating the first hydrogenated hydrocarbon cut to form hydrogen gas and a first dehydrogenated hydrocarbon cut; and
at the additional hydrocarbon processing facility to which the second hydrogenated hydrocarbon cut is transported, dehydrogenating the second hydrogenated hydrocarbon cut to form hydrogen gas and a second dehydrogenated hydrocarbon cut.

2. The method of claim 1, wherein the first hydrogenated hydrocarbon cut is a hydrogenated C₂ cut, the first dehydrogenated hydrocarbon cut is a dehydrogenated C₂ cut, the second hydrogenated hydrocarbon cut is a hydrogenated C₃ cut, and the second dehydrogenated hydrocarbon cut is a dehydrogenated C₃ cut.

3. The method of claim 2, further comprising separating the hydrocracked effluent into a hydrogenated C₄₊ cut and passing the hydrogenated C₄₊ cut back to the catalytic hydroprocessing reactor.

4. The method of claim 2, further comprising:
separating the hydrocracked effluent into a hydrogenated C₄ cut and a hydrogenated C₅₊ cut;
transporting the hydrogenated C₄ cut to an additional hydrocarbon processing facility; and
at the additional hydrocarbon processing facility, dehydrogenating the hydrogenated C₄ cut to form a dehydrogenated C₄ cut and hydrogen gas.

5. The method of claim 4, wherein each of the hydrogenated C₂ cut, the hydrogenated C₃ cut, and the hydrogenated C₄ cut are transported to separate hydrocarbon processing facilities.

6. The method of claim 4, further comprising:
separating the hydrogenated C₅₊ cut into an aromatic cut and a non-aromatic cut; and
passing the non-aromatic cut back to the catalytic hydroprocessing reactor.

7. The method of claim 6, further comprising:
hydrogenating the aromatic cut to form a naphthene cut;
transporting the naphthene cut to an additional hydrocarbon processing facility; and
at the additional hydrocarbon processing facility, dehydrogenating the naphthene cut to form an additional hydrocarbon processing facility aromatic cut and hydrogen gas.

8. The method of claim 1, further comprising separating hydrogen gas from the hydrocracked effluent.

9. The method of claim 8, further comprising passing the separated hydrogen gas back to the catalytic hydroprocessing reactor.

10. The method of claim 1, wherein the first hydrogenated hydrocarbon cut and the second hydrogenated hydrocarbon cut are transported to separate hydrocarbon processing facilities.

11. The method of claim 1, wherein the first hydrogenated hydrocarbon cut and the second hydrogenated hydrocarbon cut are transported to the same hydrocarbon processing facility.

12. A method of transporting hydrogen comprises:
at a first hydrocarbon processing facility, in a catalytic hydroprocessing reactor, hydrocracking a hydrocarbon feed comprising naphtha in the presence of hydrogen gas to form a hydrocracked effluent, wherein the hydrocracked effluent has a greater ratio of hydrogen to carbon than the hydrocarbon feed;
at the first hydrocarbon processing facility, separating the hydrocracked effluent into at least a first hydrogenated hydrocarbon stream and a second hydrogenated hydrocarbon stream;
transporting the first hydrogenated hydrocarbon stream and the second hydrogenated hydrocarbon stream from the first hydrocarbon processing facility to one or more additional hydrocarbon processing facilities, wherein the first hydrocarbon processing facility is at least 100 km apart from each additional hydrocarbon processing facility;
at the additional hydrocarbon processing facility where the first hydrogenated hydrocarbon stream is transported, dehydrogenating the first hydrogenated hydrocarbon stream to form hydrogen gas and a first dehydrogenated hydrocarbon stream; and
at the additional hydrocarbon processing facility where the second hydrogenated hydrocarbon stream is transported, dehydrogenating the second hydrogenated hydrocarbon stream to form hydrogen gas and a second dehydrogenated hydrocarbon stream.

13. The method of claim 12, wherein the first hydrogenated hydrocarbon stream is a hydrogenated C₂ stream, the first dehydrogenated hydrocarbon stream is a dehydrogenated C₂ stream, the second hydrogenated hydrocarbon stream is a hydrogenated C₃ stream, and the second dehydrogenated hydrocarbon stream is a dehydrogenated C₃ stream.

14. The method of claim 13, further comprising separating the hydrocracked effluent into a hydrogenated C₄₊ stream and recycling the hydrogenated C₄₊ stream back to the catalytic hydroprocessing reactor.

15. The method of claim 13, further comprising:
separating the hydrocracked effluent into a hydrogenated C₄ stream and a hydrogenated C₅₊ stream;
transporting the hydrogenated C₄ stream to an additional hydrocarbon processing facility; and
at the additional hydrocarbon processing facility to which the hydrogenated C₄ stream is transported, dehydrogenating the hydrogenated C₄ stream to form a dehydrogenated C₄ stream and hydrogen gas.

16. The method of claim 15, further comprising:
separating the hydrogenated C₅₊ stream into an aromatic stream and a non-aromatic stream; and
passing the non-aromatic stream back to the catalytic hydroprocessing reactor.

17. The method of claim 16, further comprising:
hydrogenating the aromatic stream to form a naphthene stream;
transporting the naphthene stream to an additional hydrocarbon processing facility; and
at the additional hydrocarbon processing facility to which the naphthene stream is transported, dehydrogenating the naphthene stream to form an additional hydrocarbon processing facility aromatic stream and hydrogen gas.

18. The method of claim 13, further comprising separating hydrogen gas from the hydrocracked effluent.

19. The method of claim 18, further comprising passing the separated hydrogen gas back to the catalytic hydroprocessing reactor.

20. The method of claim 12, wherein the first hydrogenated hydrocarbon stream and the second hydrogenated hydrocarbon stream are transported to separate hydrocarbon processing facilities.
